(19) United States
(12) Patent Application Publication
(10) Pub. No.: US 2014/0125667 A1
(43) Pub. Date: May 8, 2014

(54) Roof Generation And Texturing Of 3D Models

(71) Applicants: Emil PRAUN, Union City, CA (US); Stephen Charles HSU, San Carlos, CA (US); Xiaqing WU, San Mateo, CA (US)

(72) Inventors: Emil PRAUN, Union City, CA (US); Stephen Charles HSU, San Carlos, CA (US); Xiaqing WU, San Mateo, CA (US)

(73) Assignee: Google Inc., Mountain View, CA (US)

(21) Appl. No.: 12/944,371

(22) Filed: Nov. 11, 2010

Related U.S. Application Data
(60) Provisional application No. 61/260,260, filed on Nov. 11, 2009.

(51) Int. Cl. G06T 17/20; G06T 15/50; G06T 15/00

(52) U.S. Cl. 345/423; 345/419; 345/426

(57) ABSTRACT

System, methods and computer program product embodiments for roof generation of 3D models from ground acquired data. An embodiment includes grouping a plurality of 3D model facades and aligning each group of facades with aerial imagery. The embodiment further comprises identifying if a space between the facades is located within or outside a 3D model, generating a roof that connects plurality of facades and texturing the generated roof with the aerial imagery. In this way, when 3D data is limited to 3D model facades and lacks roof (and vertical face) information, embodiments of the invention create complete 3D models by generating a roof that connects plurality of facades and texturing the generated roof with the aerial imagery. This greatly improves user experience as 3D models closely approximate their respective real world counterparts.

### CROSS REFERENCE TO RELATED APPLICATIONS

The present application claims the benefit of U.S. Provisional Patent Application No. 61/260,260, filed on Nov. 11, 2009, entitled “Roof Generation and Texturing of 3D Models” by Praun et al. (Atty. Dkt. No. 2525.2350000), which is incorporated herein by reference in its entirety.

### BACKGROUND

1. Field

Embodiments of the present invention relate to three dimensional (3D) models, and more particularly to association of imagery with 3D models.

2. Background Art

3D mapping applications can enable users to view an entire city as a collection of 3D models that represent structures within the city. Such 3D mapping applications enable users to find an object of interest (e.g. a building), by viewing a 3D model of the object of interest, within the mapping application. For 3D mapping applications to be effective, it is important that they texture a 3D model in a manner that closely approximates a real world counterpart of the 3D model.

Ground based light detection and ranging (LIDAR) is a remote sensing system that may be used to collect topographic facade (or exterior) information of real world structures from a ground or street level. Because such information is collected from a ground or street level, 3D data lacks texture and topographic information for roofs of real world structures. Furthermore, ground based LIDAR may not be able to collect facade information for sides of the structures that do not face a street. Therefore, when mapping applications render such 3D data that lacks roof information, it results in 3D models that do not approximate their respective real world counterparts. Furthermore, all neighboring 3D models appear to have similar facades. This greatly degrades user experience.

### BRIEF SUMMARY

Embodiments of the present invention relate to roof generation of 3D models from ground acquired facade data. An embodiment includes grouping a plurality of 3D model facades and aligning each group of facades with aerial imagery. The embodiment further comprises identifying if a space between the facades is located within or outside a 3D model and generating a roof that connects the group of facades. The generated roof may then be textured with the aerial imagery.

In this way, when 3D data is limited to 3D model facades and lacks roof information, embodiments of the invention create complete 3D models by generating a roof that connects a plurality of facades and texturing the generated roof with aerial imagery. This greatly improves user experience as the 3D models closely approximate their respective real world counterparts.

Further embodiments, features, and advantages of the invention, as well as the structure and operation of the various embodiments of the invention are described in detail below with reference to accompanying drawings.

### BRIEF DESCRIPTION OF THE DRAWINGS

Embodiments of the present invention are described with reference to the accompanying drawings. In the drawings, like reference numbers may indicate identical or functionally similar elements. The drawing in which an element first appears is generally indicated by the left-most digit in the corresponding reference number.

FIG. 1 is diagram illustrating a system for roof generation of 3D models, according to an embodiment.

FIG. 2 illustrates exemplary facade edges received by a grouping module, according to an embodiment.

FIG. 3A illustrates an exemplary top-down view of the facade edges of FIG. 2, according to an embodiment.

FIG. 3B illustrates exemplary neighboring facade edges, according to an embodiment.

FIG. 4 is a flowchart illustrating an exemplary operation of a grouping module, according to an embodiment.

FIG. 5A illustrates exemplary aerial imagery and a plurality of facade edges associated with the aerial imagery, according to an embodiment.

FIG. 5B illustrates the aerial imagery and the plurality of facade edges of FIG. 5A, after alignment, according to an embodiment.

FIG. 6A is a flowchart illustrating an exemplary edge detection based alignment method, according to an embodiment.

FIG. 6B illustrates exemplary inputs and outputs of the edge detection based alignment method, according to an embodiment.

FIG. 6C is a flowchart illustrating an exemplary entropy based alignment method, according to an embodiment.

FIG. 6D illustrates exemplary inputs and outputs of the entropy based alignment method, according to an embodiment.

FIG. 6E is a flowchart illustrating an exemplary overall alignment method, according to an embodiment

FIG. 7A illustrates an exemplary output of a roof generation module, according to an embodiment.

FIG. 7B illustrates an exemplary output of a roof generation module, according to another embodiment.

FIG. 8 is a flowchart illustrates an exemplary overall method for roof generation, according to an embodiment.

FIG. 9 illustrates an exemplary overall output of roof generation module, according to an embodiment.

FIG. 10 illustrates an example computer useful for implementing components of embodiments of the invention.

### DETAILED DESCRIPTION

Embodiments of the present invention relate to roof generation of 3D models from ground acquired facade data. An embodiment includes grouping a plurality of 3D model facades and aligning each group of facades with aerial imagery. As an example, such aerial imagery is top-down (e.g. Nadir) aerial imagery. The embodiment further comprises identifying if a space between the facades is located within or outside a 3D model and generating a roof that connects the group of facades. The generated roof may then be textured with the aerial imagery.

In this way, when 3D data is limited to 3D model facades and lacks roof information, embodiments of the invention create complete 3D models by generating a roof that connects a plurality of facades and texturing the generated roof with aerial imagery. This greatly improves user experience as 3D models closely approximate their respective real world counterparts.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

This detailed description of the embodiments of the present invention is divided into several sections as shown by the following table of contents.

### Table of Contents

1. System
2. Grouping of 3D Model Facades
3. Imagery Alignment
4. Roof Generation
5. Example Computer Embodiment

### 1. System

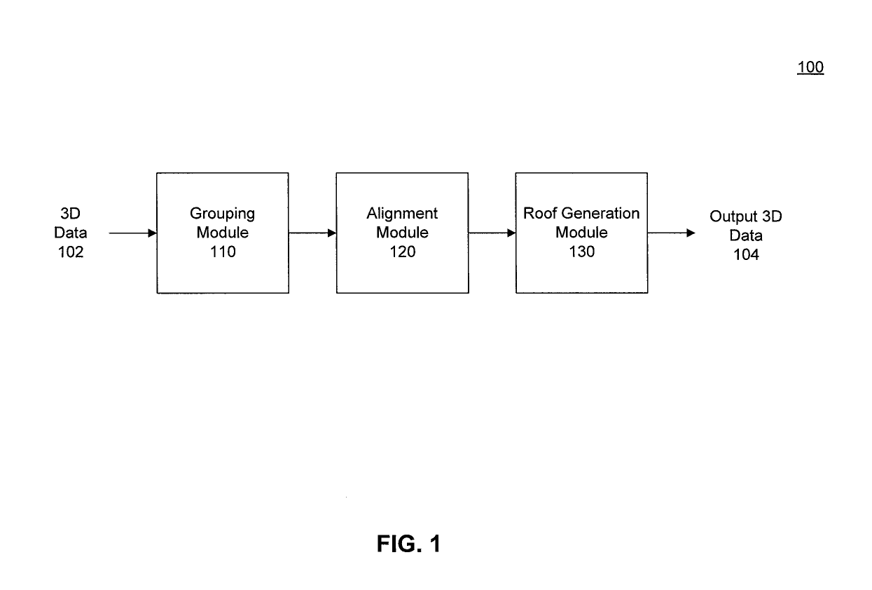

This section describes a system for roof generation of 3D models from ground acquired facade data, according to an embodiment of the invention illustrated in FIG. 1. FIG. 1 is a diagram of system 100 for roof generation of 3D models from ground acquired facade data. While the following is described in terms of roof generation and aerial imagery, embodiments of the invention are not limited to this embodiment. Embodiments of the invention can be used in conjunction with any other form of imagery such as user or computer generated imagery. Furthermore, embodiments of the invention may be used to generate faces other than roofs of 3D models. For example, embodiments of the invention can be used in any system having generally the structure of FIG. 1, or that would benefit from the operation, methods and functions as described herein.

System 100 includes grouping module 110, alignment module 120 and roof generation module 130. In an embodiment, grouping module 110 receives 3D data 102 and roof generation module 130 generates output 3D data 104. As an example, not intended to limit the invention, 3D data 102 can include a plurality of 3D models (e.g. buildings). Furthermore, as an example, 3D model data 102 is limited to facade (or exterior face) information for a plurality of 3D models. Therefore, such 3D models lack roofs.

As an example, 3D model facade information may be obtained from ground based LIDAR techniques. Ground based LIDAR is well known to those skilled in the art and is a remote sensing system that may be used to collect topographic facade (or exterior) information of real world structures from a ground or street level. Thus, for example, a car equipped with LIDAR apparatus may travel around city streets scanning facade (or exterior face) information of real world buildings.

Grouping module 110, alignment module 120 and roof generation module 130 may be implemented on any device (or a plurality of devices)that can support graphics processing and rendering. Such a device can include, but is not limited to, a personal computer, a group of networked computers, mobile device such as a mobile phone, workstation, embedded system, game console, television, set-top box, or any other computing device that can support computer graphics and image processing. Such a device may include, but is not limited to, a device having one or more processors and memory for executing and storing instructions. Such a device may include software, firmware, and hardware. Software may include one or more applications and an operating system. Hardware can include, but is not limited to, a processor, memory and a display.

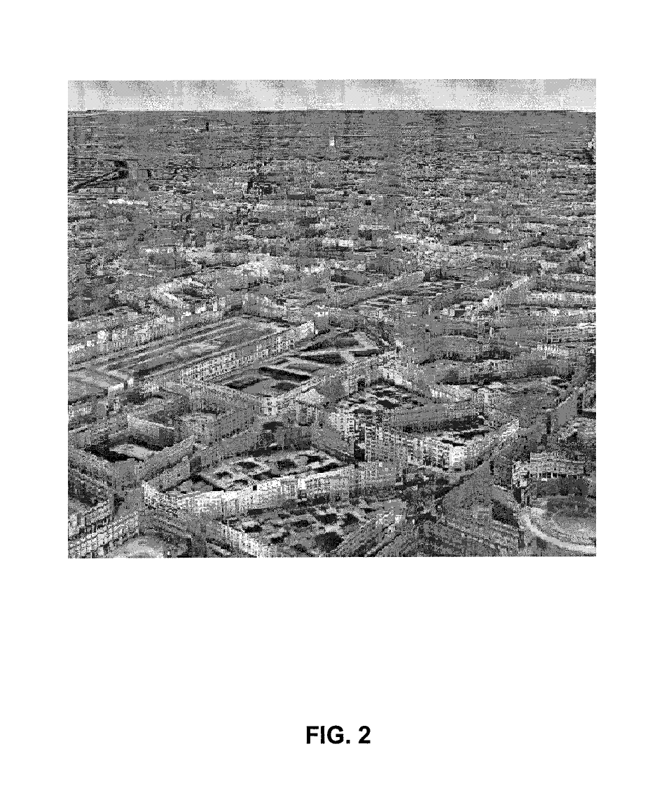

FIG. 2 illustrates exemplary 3D data received by grouping module 110. As shown in FIG. 2, because such 3D data is collected from a ground or street level, the 3D data lacks texture and topographic information for roofs of real world structures or even the sides of the structures that do not face a street. Instead, the 3D data includes primarily 3D facade information of the real world structures. Therefore, when mapping applications render such 3D data that lacks roof information, it results in rendered 3D models that do not approximate their respective real world counterparts. Furthermore, as shown in FIG. 2, all neighboring 3D models appear to have similar facades. This greatly degrades user experience because a user is unable to identify 3D models of interest.

As discussed above, when 3D data is limited to 3D model facades and lacks roof information, embodiments of the invention create complete 3D models by generating a roof that connects a plurality of facades and then texturing the generated roof with the aerial imagery (e.g. top-down aerial imagery). This greatly improves user experience as 3D models closely approximate their respective real world counterparts.

### 2. Grouping of 3D Model Facades

In an embodiment, grouping module 110 groups a plurality of 3D model facades present in 3D data 102. As discussed earlier, for example, such 3D facade information may be obtained from ground based LIDAR techniques and lacks roof and portions of hidden exterior face information.

In an embodiment, grouping module 110 groups 3D model facades into groups (e.g. groups associated with city blocks) and identifies if a space between the facades is located within or outside a 3D model. In an embodiment, for example, grouping module 110 labels space between the facades as being inside a 3D building or outside the 3D building. In an embodiment, when 3D data 102 is missing facade data, includes structures incorrectly classified as facades, or even includes misaligned facade data, grouping module 110 may add facade data using LIDAR data or remove (or reclassify) incorrectly classified structures.

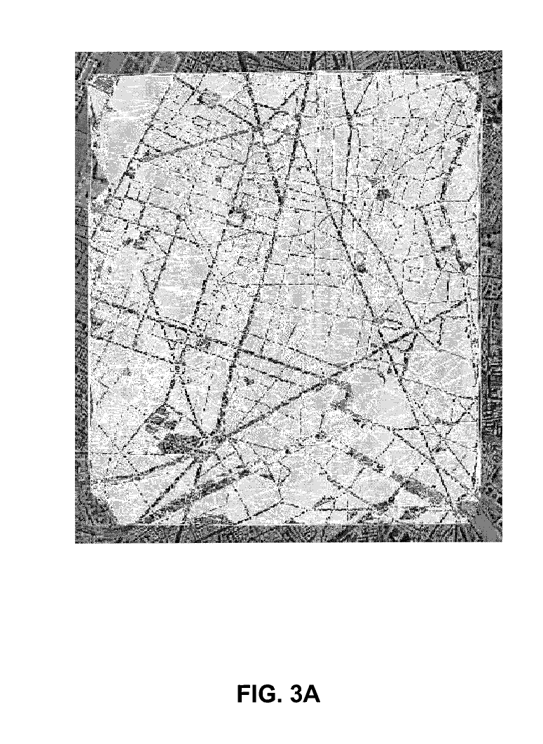

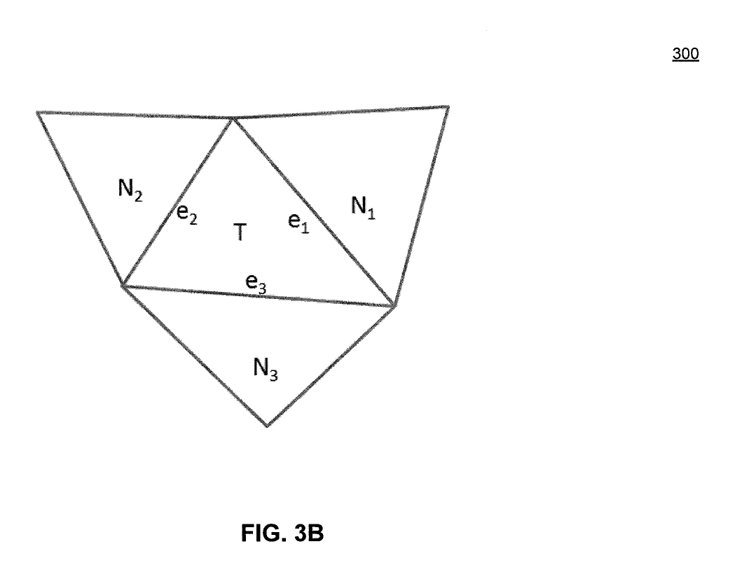

In an embodiment, grouping module 110 receives facade edges and produces a triangulated mesh representing the received facade edges. As discussed earlier, FIG. 2 illustrates exemplary facade edges received by grouping module 110. As an example, such 3D model facade information may be obtained from ground based LIDAR techniques. Grouping module 110 labels facade elements in the triangulated mesh as being inside or outside a 3D model (e.g. a building). In an embodiment, to produce a triangulated mesh, grouping module 110 performs a triangulation (e.g. a constrained Delaunay triangulation) of the top-down view of the facade segments. FIG. 3A illustrates an exemplary top-down view of the facade edges of FIG. 2, according to an embodiment.

A Delaunay triangulation is known to those skilled in the art. Delaunay triangulations may maximize the minimum angle of all angles of triangles in the triangulation and tend to avoid ‘skinny’ triangles.

Grouping module 110 labels each triangle in the triangulated mesh as being inside or outside a 3D model by solving a linear system. As an example, such a linear system propagates a belief that a location is interior or exterior of a 3D model. The linear system, for example, is constrained by areas immediately in front of facades which are labeled “outside”. As an example, grouping module 110 labels each facade (or exterior face) with an “interiorness” factor. As an example, the interiorness factor may have a value between −1 and 1.

In an embodiment, once the triangles have been identified as being inside or outside a 3D model and labeled accordingly by grouping module 110, grouping module 110 extracts connected (or grouped) components of interior facades.

In an embodiment, the constraints of the linear system are provided by faces that are adjacent to facade walls, and in front of the facade walls. The values for other facades can be a linear combination of their neighbor facade values, weighted by the edge lengths, and with a sign change across edges corresponding to facade walls. In an embodiment, grouping module 110 solves the system using a linear least squares solver (e.g. conjugate gradient, etc.).

In an embodiment, grouping module 110 determines an interiorness factor of a facade, I(f), using the following equation.

$$I ( f ) = \frac{{\sum }_{i = 0}^{2} I ( {n}_{f , i} ) ‖ {e}_{i} ‖ s ( {e}_{i} )}{‖ {e}_{i} ‖}$$

where,

f is a mesh face (e.g. a triangle)

eᵢ is one of the edges of a facade

n_{f,i} is the neighboring facade across edge i

∥ ∥ represents the length of a facade (e.g. a Euclidean norm)

s(e,) is set to ‘1’ by grouping module 110 for internal mesh edges, and is set to ‘−1’ for edges that are part of input facade edges. The values of ‘1’ and ‘−1’ are purely illustrative and another values or identifiers may be used by grouping module 110. Also, input facades may be split into several smaller segments by grouping module 110 if the edges intersect each other.

FIG. 3B illustrates exemplary neighboring facade edges. In FIG. 3B, assume that e represents a facade edge, while e₂ and e₃ are not facades edges. Therefore, in this example, grouping module 110 determines an interiorness factor “I(T)”of facade e₁ using the equation shown below.

$$I ( T ) = \frac{- ‖ {e}_{1} ‖ I ( {N}_{1} ) + ‖ {e}_{2} ‖ I ( {N}_{2} ) + ‖ {e}_{3} ‖ I ( {N}_{3} )}{‖ {e}_{1} ‖ + ‖ {e}_{2} ‖ + ‖ {e}_{3} ‖}$$

Thus, in the above exemplary equation, an interiorness value of a facade, I(T), can be a linear combination of its neighbor facade values (N₁, N₂ and N₃), weighted by the edge lengths (∥e₁∥, ∥e₂∥ and ∥e₃∥), and with a sign change across edges corresponding to facade walls.

It is to be appreciated that the interiorness factor determination and inside/outside labeling may be performed by grouping module 110 using other methods, including, but not limited to, graph-cuts and space carving. For example, space carving may include labeling facade areas seen as outside based on the LIDAR data and street LIDAR acquisition locations while assuming that all other space is inside a 3D model.

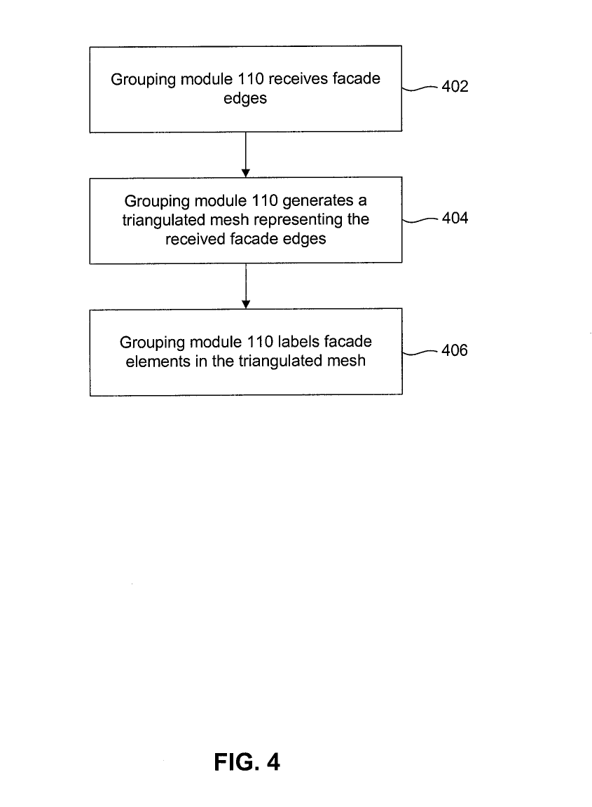

FIG. 4 is a flowchart 400, illustrating an exemplary operation of grouping module 110, according to an embodiment.

Method 400 begins with grouping module 110 receiving facade edges (step 402). FIG. 2 illustrates an exemplary facade edges received by grouping module 110.

Grouping module 110 then produces a triangulated mesh representing the received facade edges (step 404). In an embodiment, to produce a triangulated mesh, grouping module 110 performs a constrained Delaunay triangulation of a top-down view of the received facade edges.

Grouping module 110 labels facade elements in the triangulated mesh as being inside or outside a 3D model (e.g. a building) (step 406). In an embodiment, grouping module 110 labels each triangle in the triangulated mesh as being inside or outside a 3D model by solving a linear system. As an example, such a linear system propagates a belief that a location is interior or exterior of a 3D model. The linear system is constrained by the areas immediately in front of facades. Such areas are labeled “outside”. As an example, grouping module 110 labels each facade (or exterior face) with an interiorness factor. As an example, the interiorness factor may have a value between −1 and 1. In an embodiment, after grouping module 110 labels facade elements, grouping module 110 may group facade edges using a connected component algorithm (or any other algorithm) on faces labeled as ‘inside’. As an example, facades that share an edge are grouped or connected.

### 3. Imagery Alignment

In an embodiment, alignment module 120 aligns aerial imagery (e.g. top-down aerial imagery) with the 3D model facades grouped by grouping module 110. As a purely illustrative example, aerial imagery may be obtained by using aerial photography techniques over an area of interest in a city. Aerial imagery may be misaligned with 3D model facades because of global positioning system (GPS) errors in the received aerial satellite data, image mosaic errors, building lean widths, sparse facades and facade grouping errors. Thus, it is important for aerial imagery to be accurately aligned with edges of the facades to so that 3D models closely approximate their respective real world counterparts.

In an embodiment, alignment module 120 may align imagery using two different methods and then retain results where the results computed separately from both methods are in agreement (e.g. equal valued). In an embodiment, alignment module 120 uses an entropy based method and a edge detection (luminance) based method to align aerial imagery.

In an embodiment, in the edge detection based method, alignment module 120 produces an edge image by filtering the aerial imagery and linking edge pixels to construct line segments. Alignment module 120 may then match the given facade segments obtained from grouping module 110 to candidate constructed line segments that are parallel and close to the facade segments. Alignment module 120 then determines an alignment match based on an image intensity difference across two sides of each constructed line segment.

In an embodiment, in the entropy based method, alignment module 120 constructs a template image that includes half dark and half bright regions (or pixels) such that the dark-bright transition is parallel to each facade edge. Alignment module 120 then determines a value of translation that maximizes mutual information between the templates for all facades in a group and the aerial imagery. This determined value of translation, for example, represents an alignment match.

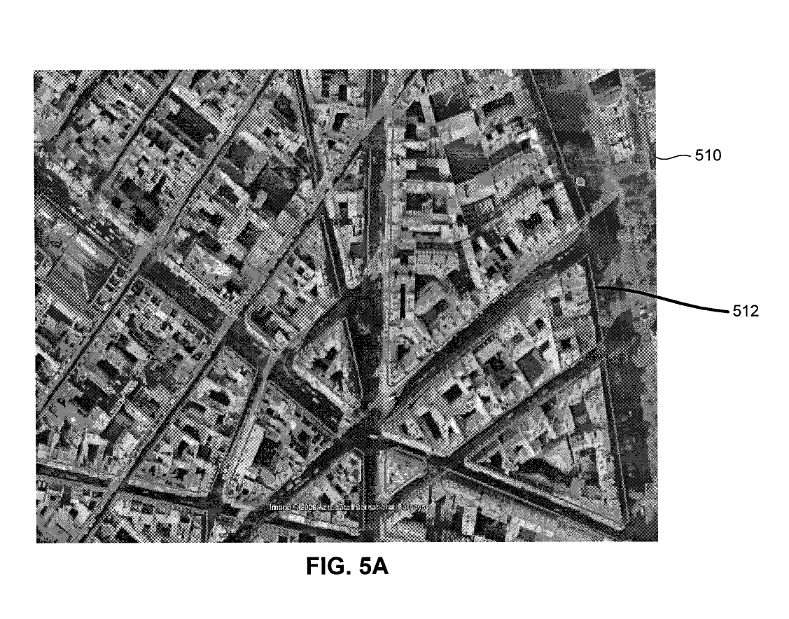

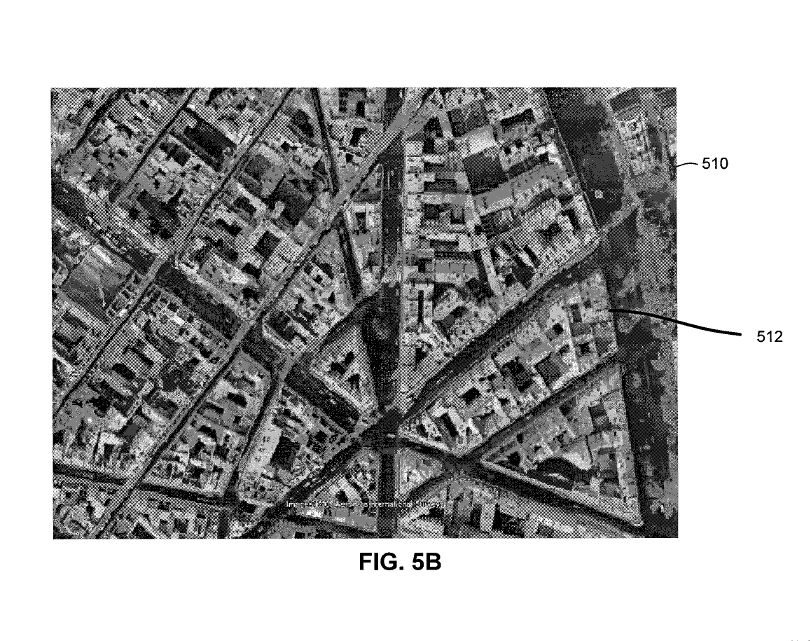

FIG. 5A illustrates aerial imagery 510 and a plurality of facade edges 512 associated with the aerial imagery. As shown in FIG. 5A, aerial imagery 510 is misaligned with facade edges 512. If aerial imagery misaligned with facade edges is textured to a roof generated by roof generation module 130, it may result in an inaccurate 3D model and may appear distorted to a user. As discussed above, alignment module 120 aligns aerial imagery with grouped 3D model facades.

FIG. 5B illustrates aerial imagery 510 and a plurality of facade edges 512 after alignment by alignment module 120. As is apparent in FIG. 5B, aerial imagery 510 has been more closely aligned with facade edges 512.

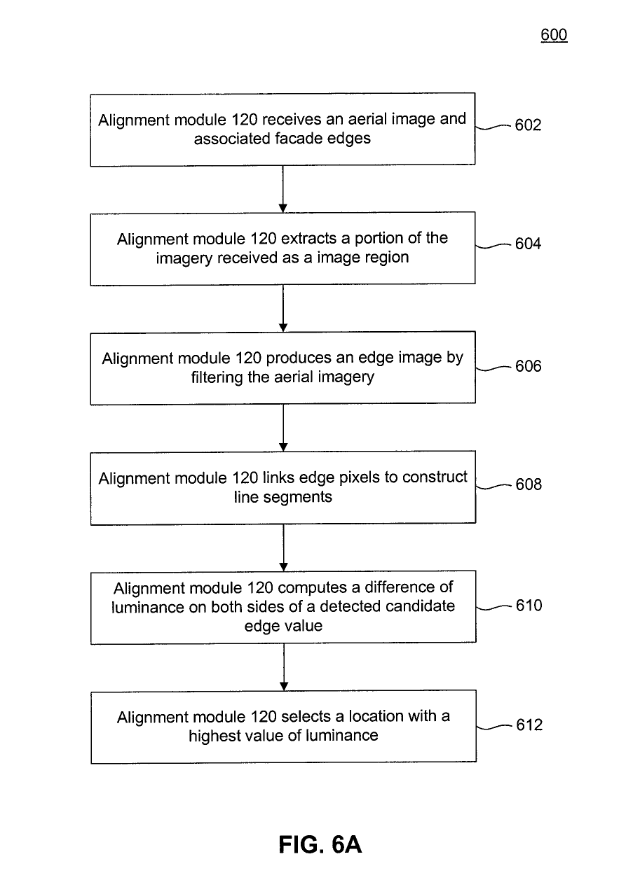

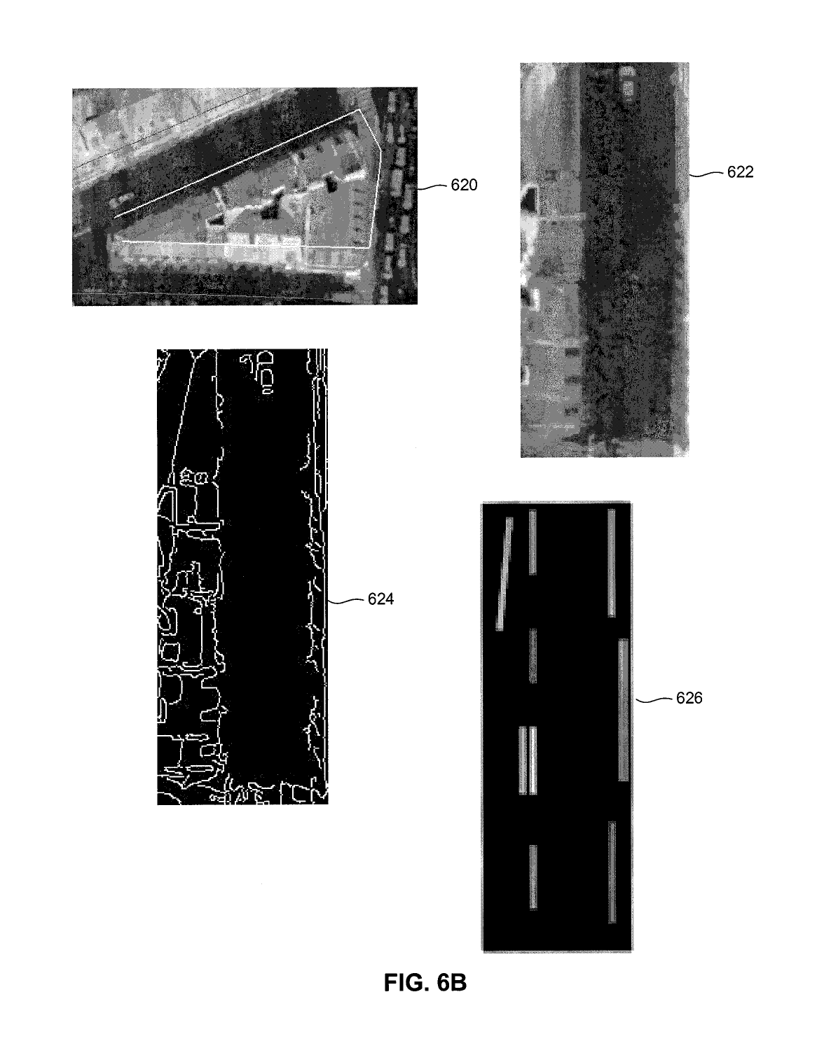

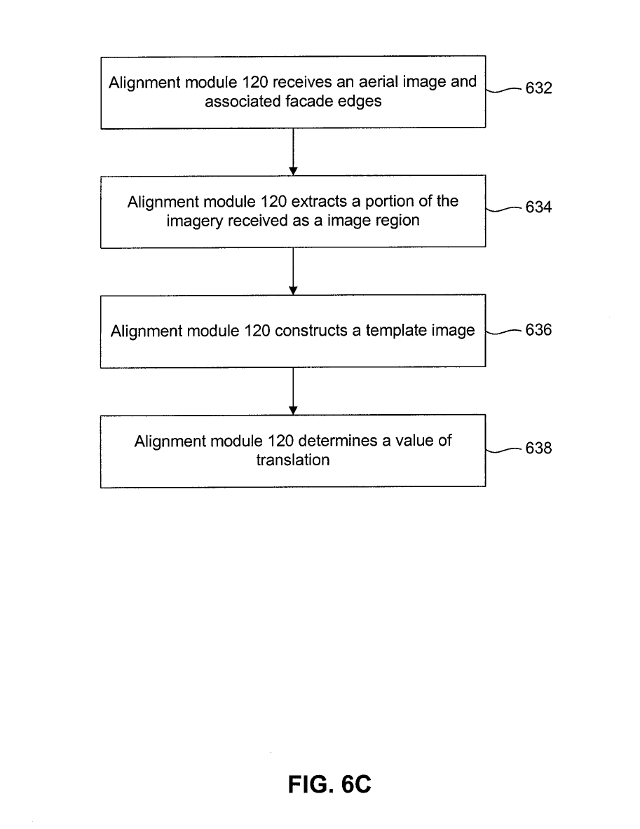

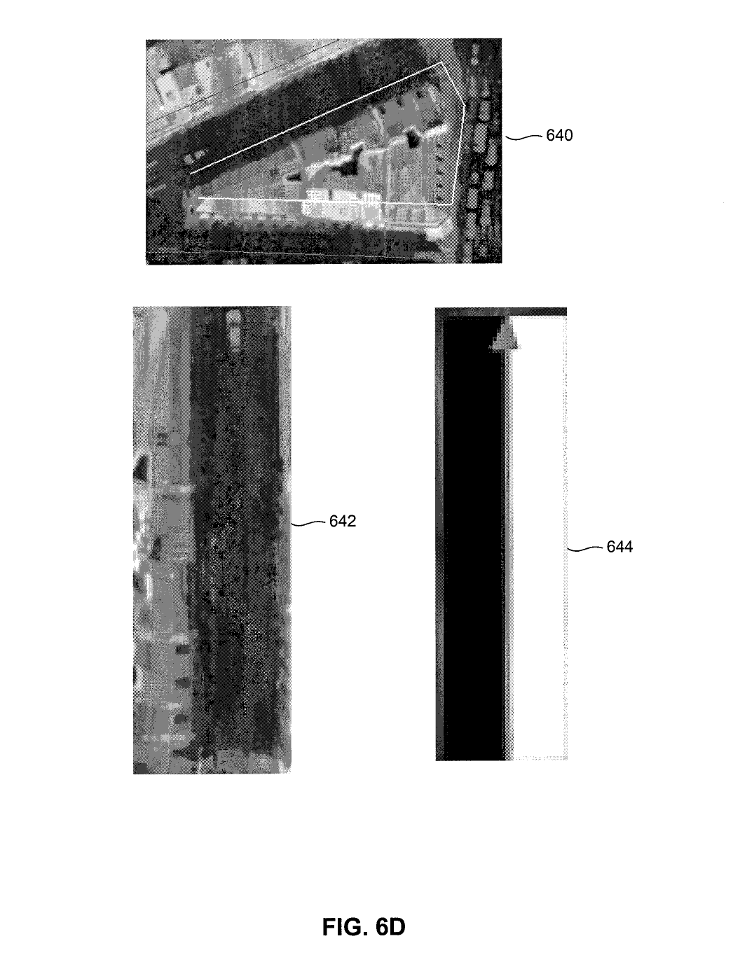

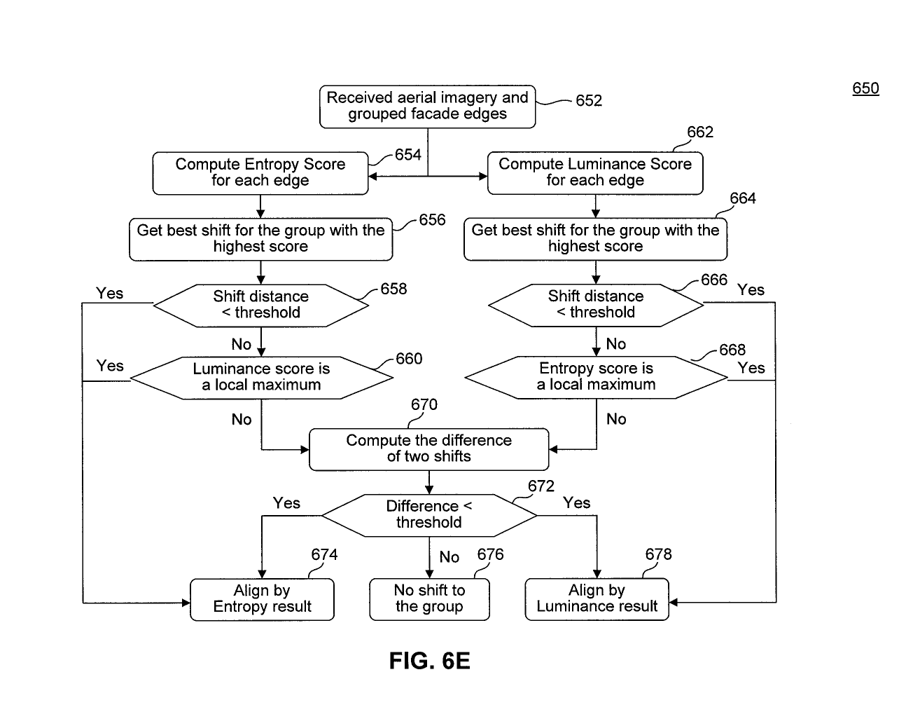

FIG. 6A is a flowchart 600 illustrating an exemplary edge detection (luminance) based alignment method, according to an embodiment.

Method 600 begins with alignment module 120 receiving an aerial image and associated facade edges (step 602). As an example, referring to FIG. 6B, alignment module 120 may receive aerial imagery and facade edges 620.

Alignment module 120 then extracts a portion of the imagery received in step 602 as a image region (or buffer) (step 604). As an example, referring to FIG. 6B, alignment module 120 may extract image region 622.

Alignment module 120 produces an edge image by filtering the aerial imagery (step 606). As an example, an edge image may be produced by a Canny edge detection algorithm. The Canny edge detection algorithm is well known to those skilled in the art. FIG. 6B illustrates an exemplary edge detected region 624 that has been obtained by edge detecting search region 622, according to an embodiment.

Alignment module 120 then links edge pixels to construct line segments (step 608). As an example, edge linking may be performed using a Vista algorithm. The Vista edge linking algorithm is an open source algorithm available at http://www.cs.ubc.ca/nest/lci/vista/vista.html. FIG. 6B illustrates exemplary edge segments 626 that have been obtained by linking edge pixels of edge detected region 624, according to an embodiment.

Alignment module 120 may then compute a difference of luminance on both sides of a detected candidate edge value (step 610). As an example, the alignment module 120 computes a left to right difference of luminance on both sides of a detected candidate edge value.

Alignment module 120 then selects a location with a highest value of luminance difference computed in step 606 (step 612). As an example, not intended to limit the invention, alignment module 120 then selects a location with a highest positive value of luminance difference computed in step 606.

In this way, alignment module 120 may then match the given facade segments obtained from grouping module 110 to candidate constructed segments that parallel and close to the facade segments. As an example, alignment module 120 determines an alignment match based on a image intensity difference across two sides of the segment.

FIG. 6C is a flowchart 630 illustrating an exemplary entropy based alignment method, according to an embodiment.

Method 630 begins with alignment module 120 receiving an aerial image and associated facade edges (step 632). As an example, referring to FIG. 6D, alignment module 120 may receive aerial imagery and facade edges 640.

Alignment module 120 then extracts a portion of the imagery received in step 602 as a image region (or buffer) (step 634). As an example, referring to FIG. 6D, alignment module 120 may extract image region 642.

Alignment module 120 constructing a template image that include half dark and half bright regions (or pixels) such that the dark/bright transition is parallel to each facade edge (step 636). As an example, referring to FIG. 6D, alignment module 120 may construct a template image 644.

Alignment module 120 then determines a value of translation that maximizes mutual information between the templates for all the facades in a group and the aerial imagery (step 638). In an embodiment, not intended to limit the invention, normalized mutual information I (X,Y) may be computed as:

I(X,Y)=(H(X)+H(Y))/H(X,Y)

Where,

I(X,Y) is a value of normalized mutual information.

H(X) is the entropy of (Histogram(Image)), where Image can be a image region extracted by alignment module 120 (e.g. image region 642) or an entire image.

H(X) is the entropy of (Histogram(Template)), where Template can be a template determined by alignment module 120 (e.g. template image 644), and

H(X,Y)=Entropy (Joint_Histogram (Image, Template)).

FIG. 6E is a flowchart 650 illustrating an exemplary overall alignment method, according to an embodiment.

Method 650 begins alignment module 120 receiving aerial imagery and grouped facade edges from grouping module 110 (step 652). Alignment module 120 computes an entropy score for each facade (step 654) and also a luminance score for each edge (step 662).

Referring to the entropy based method, alignment module 120 determines an optimal shift distance for a facade group based on the entropy score computed in step 654 (step 656). As an example, the optimal shift distance is the distance needed to accurately align the aerial imagery with the facade edges. Alignment module 120 then checks if the shift distance computed in step 656 is less than a threshold value (step 658). If the shift distance is less than a threshold value (step 658), alignment module 120 proceeds to align the aerial imagery with the facade group using the shift distance computed in step 656 (step 674). If the shift distance is not less than a threshold value (step 658), alignment module checks if a luminance score (computed using the edge detection based method) is a local maximum luminance score value (step 660). If the luminance score is a local maximum luminance score value (step 660), alignment module 120 proceeds to align the aerial imagery with the facade group using the shift distance computed in step 656 (step 674).

Referring to the edge detection (or luminance) based method, alignment module 120 computes a luminance score for each facade edge (step 662). Alignment module 120 determines an optimal shift distance for a facade group based on the luminance computed in step 662 (step 664). As an example, the optimal shift distance is the distance needed to accurately align the aerial imagery with the facade edges. Alignment module 120 then checks if the shift distance computed in step 664 is less than a threshold value (step 666). If the shift distance is less than a threshold value (step 666), alignment module 120 proceeds to align the aerial imagery with the facade group using the shift distance computed in step 664 (step 678). If the shift distance is not less than a threshold value (step 666), alignment module 120 checks if an entropy score is a local maximum entropy score value (step 668). If the local luminance score is a local maximum luminance score value (step 668), alignment module 120 proceeds to align the aerial imagery with the facade group using the shift distance computed in step 664 (step 678).

Returning to step 660 in the entropy based method and step 668 in the edge detection (or luminance) based method, if the local luminance score is not a local maximum luminance score value (step 660) and if the local entropy score is not a local maximum entropy score value (step 668), alignment module 120 computes a difference between the shift distances computed in steps 656 and 664 (step 670). Alignment module 120 then determines if the difference computed in step 670 is less than a threshold value (step 672). If the difference is less than a threshold value (step 672), alignment module 120 proceeds to step 674 and/or step 678. If the difference is not less than a threshold value (step 672), alignment module does not align (or shift) the aerial imagery with the facade group (step 676).

In this way, alignment module 120 compares alignment results obtained from both the entropy based and the edge detection based methods.

### 4. Roof Generation

In an embodiment, roof generation module 130 generates a flat roof connecting all facade edges grouped by grouping module 110. Roof generation module 130 then textures the generated roof with aerial imagery that has been aligned by alignment module 120.

In an embodiment, to generate a roof connecting facade edges, roof generation module 130 determines a number of facades in a given area (e.g. a city block(s) or an area in a city block).

In an embodiment, for areas (or city blocks) with facades that exceed a pre-determined threshold value, roof generation module 130 creates a flat roof connecting all the facades. In this embodiment, if the grouped facades in the area have different heights, roof generation module segments the roof into a plurality of flat terraces. In an embodiment, roof generation module 130 segments the roof in a manner that places the steps between the terraces at strong edges detected in the aerial imagery. Roof generation module 130 then textures the roof with the aligned aerial imagery, and colors the steps between the terraces with a predetermined color value (e.g. a uniform gray color).

Starting with triangulation for a facade-enclosed city block, roof generation module 130 inserts additional edges corresponding to strong edges in the aerial imagery. As an example, additional edges may be obtained by roof generation module 130 by filtering the imagery with an edge detector and linking the edge pixels into segments.

Roof generation module 130 may then label the resulting triangulation by assigning a height label to each facade. In an embodiment, the labeling by roof generation module 130 is done using a graph cut optimization, where the cost of cutting an edge (placing a terrace step) is influenced by the angle of the edge with respect to the facade edges nearby, and whether the edge corresponds to an edge in the imagery. Faces adjacent to a facade may be constrained to the facade's height. Connected groups of roof faces with the same height may form a terrace, and roof generation module 130 can generate steps between different terraces.

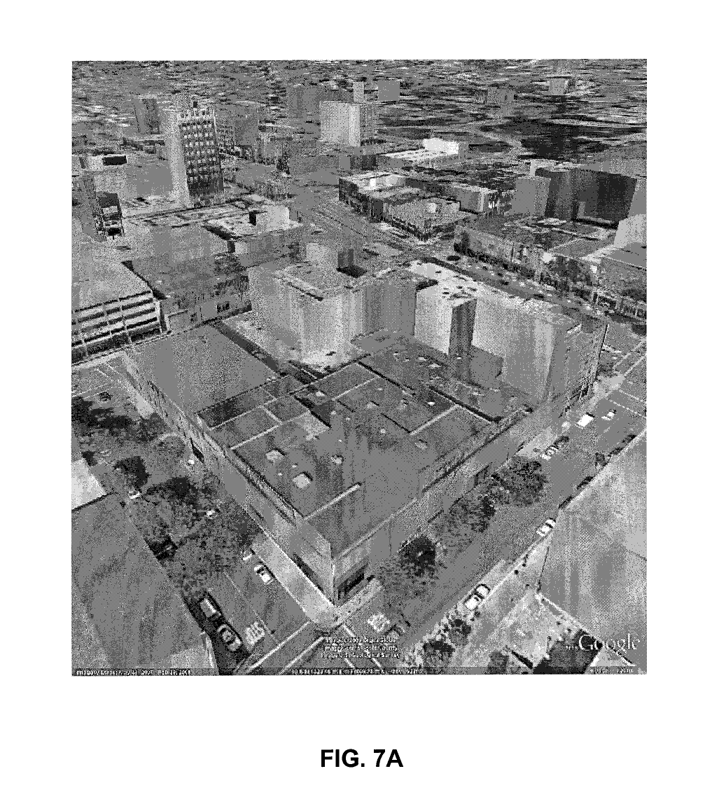

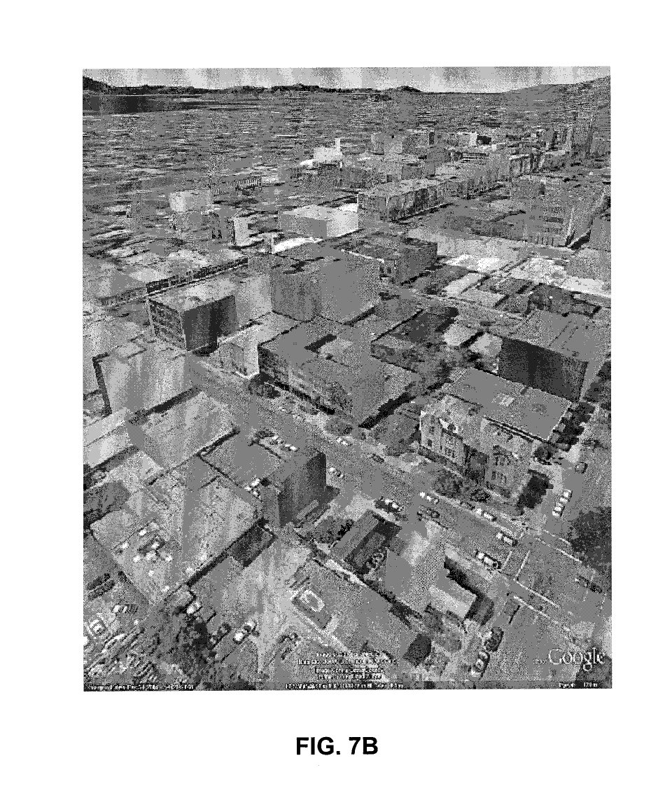

FIG. 7A illustrates an exemplary output of roof generation module, according to an embodiment. As shown in FIG. 7A, the facades have been connected with a roof generated by roof generation module 130. In the scenario illustrated in FIG. 7A, the number of facades exceed a predetermined threshold value. Thus, roof generation module 130 creates a flat roof connecting all the facades. Additionally, if the grouped facades in an area have different heights, roof generation module 130 segments the roof into a plurality of flat terraces.

In another embodiment, for areas (or city blocks) with facades that do not meet (e.g. lie below) a pre-determined threshold value, roof generation module 130 extends each facade by a box. Roof generation module 130 then determines the depth of the box by identifying strong edges parallel to the facade in the aerial imagery.

In an embodiment, to determine the depth of the box associated with a facade, roof generation module 130 extracts aerial imagery behind the facade, and filters the extracted aerial imagery to obtain an edge image. Roof generation module 130 then sweeps a line parallel to the facade. Roof generation module 130 scores the sweep based on a number of edge pixels covered by the sweep, and according to any prior distribution assumptions on expected building depths. Finally, the box used to extend the facade is trimmed to space labeled as being inside a 3D model by roof generation module 130. Roof generation module 130 then textures the roof with the aerial imagery, and colors the side walls (or vertical) between the terraces with a predetermined color value (e.g. a uniform gray color).

FIG. 7B illustrates an exemplary output of roof generation module, according to an embodiment. As shown in FIG. 7B, the facades have been connected with a roof generated by roof generation module 130. In the scenario illustrated in FIG. 7B, the number of facades do not exceed a predetermined threshold value. Thus, roof generation module 130 may extend each facade by a box and may trim the box to the space labeled as being inside a 3D model. Roof generation module 130 then textures the roof with the aerial imagery, and colors the side walls (or vertical) between the terraces with a predetermined color value (e.g. a uniform gray color).

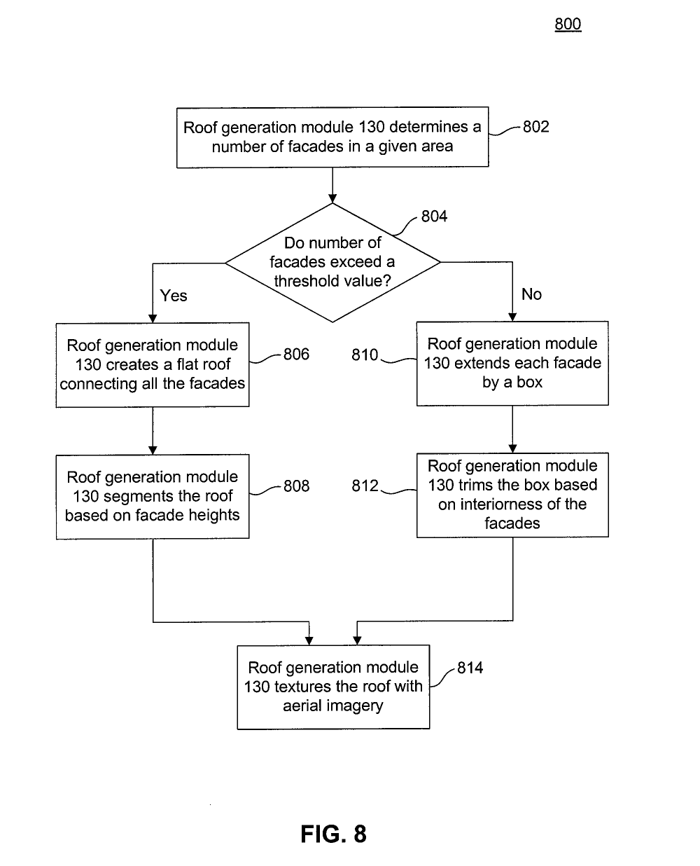

FIG. 8 illustrates method 800 for roof generation by roof generation module 130, according to an embodiment.

Method 800 begins with roof generation module 130 determining a number of facades in a given area (e.g. a city block(s) or an area in a city block) (step 802).

Roof generation module 130 then checks if the number of facades determined in step 802 exceeds a predetermined threshold value (step 804).

If the number of facades determined in step 802 exceed a predetermined threshold value (step 804), roof generation module 130 generates a flat roof connecting the facades (step 806). Roof generation module 130 segments the roof into step terraces based on facade heights (step 808) and textures the roof with aerial imagery (step 814). Roof generation module 130 may also color the steps between the terraces with a predetermined color value (e.g. a uniform gray color).

Returning to step 804, if the number of facades determined in step 802 do not exceed a predetermined threshold value (step 804), roof generation module 130 extends each facade by a box (step 810). Roof generation module 130 then trims each box based on the interiorness of space surrounding facades extended with the box (step 812) and textures the roof with aerial imagery (step 814). Also as discussed earlier, roof generation module 130 may color the side walls (or vertical) between the terraces with a predetermined color value (e.g. a uniform gray color).

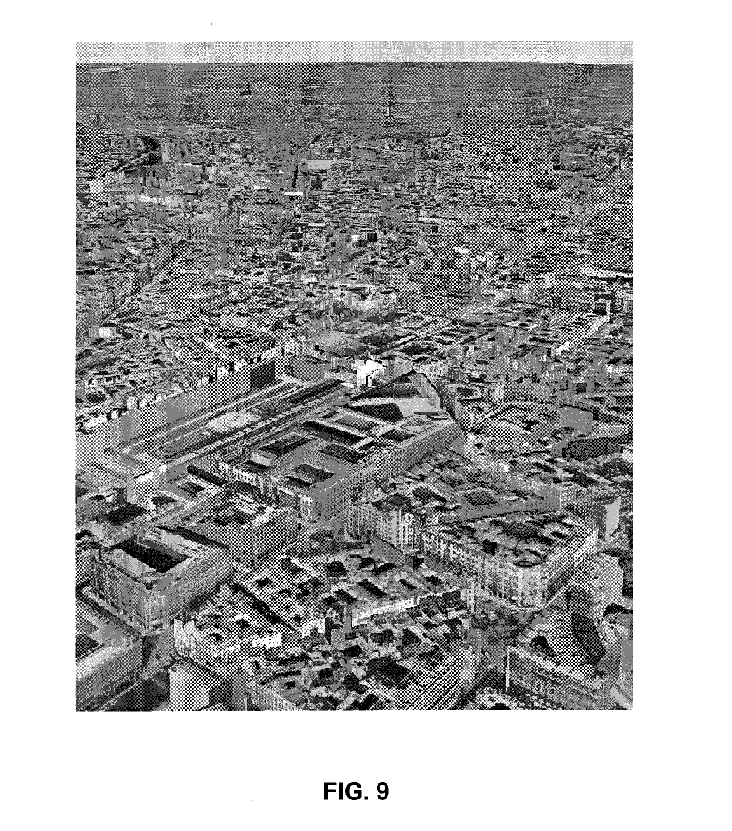

FIG. 9 illustrates an exemplary overall output of roof generation module, according to an embodiment. As an example, the output illustrated in FIG. 9 may be obtained by rendering output 3D data 104. In particular, FIG. 9 represents the facades of FIG. 2 after they processing by roof generation module 130. As shown in FIG. 9, it is apparent that when 3D data is limited to 3D model facades and lacks roof information, embodiments of the invention create complete 3D models by generating a roof that connects a plurality of facades and texturing the generated roof with aerial imagery. This greatly improves user experience as 3D models closely approximate their respective real world counterparts.

### 5. Example Computer Embodiment

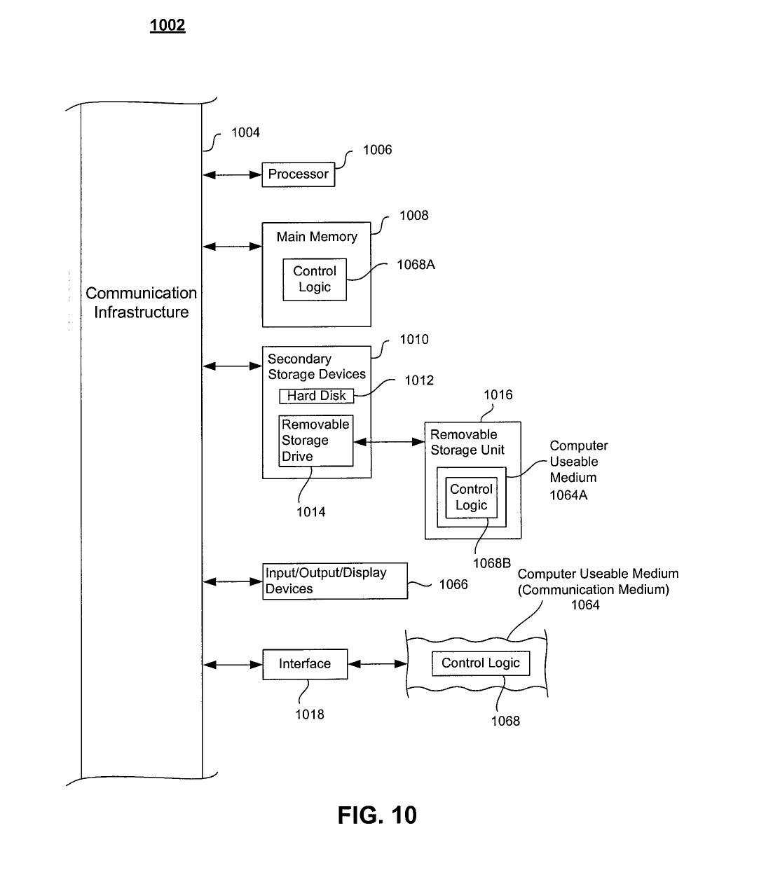

In an embodiment of the present invention, the system and components of embodiments described herein are implemented using well known computers, such as example computer 1002 shown in FIG. 10. For example, grouping module 110, alignment module 120 and roof generation module 130 can be implemented using computer(s) 1002.

The computer 1002 can be any commercially available and well known computer capable of performing the functions described herein, such as computers available from International Business Machines, Apple, Sun, HP, Dell, Compaq, Cray, etc.

The computer 1002 includes one or more processors (also called central processing units, or CPUs), such as a processor 1006. The processor 1006 is connected to a communication infrastructure 1004.

The computer 1002 also includes a main or primary memory 1008, such as random access memory (RAM). The primary memory 1008 has stored therein control logic 10210A (computer software), and data.

The computer 1002 also includes one or more secondary storage devices 1010.

The secondary storage devices 1010 include, for example, a hard disk drive 1012 and/or a removable storage device or drive 1014, as well as other types of storage devices, such as memory cards and memory sticks. The removable storage drive 1014 represents a floppy disk drive, a magnetic tape drive, a compact disk drive, an optical storage device, tape backup, etc.

The removable storage drive 1014 interacts with a removable storage unit 1016.

The removable storage unit 1016 includes a computer useable or readable storage medium 1024 having stored therein computer software 1028B (control logic) and/or data. Removable storage unit 1016 represents a floppy disk, magnetic tape, compact disk, DVD, optical storage disk, or any other computer data storage device. The removable storage drive 1014 reads from and/or writes to the removable storage unit 1016 in a well known manner.

The computer 1002 also includes input/output/display devices 1022, such as monitors, keyboards, pointing devices, etc.

The computer 1002 further includes a communication or network interface 1018. The network interface 1018 enables the computer 1002 to communicate with remote devices. For example, the network interface 1018 allows the computer 1002 to communicate over communication networks or mediums 1024B (representing a form of a computer useable or readable medium), such as LANs, WANs, the Internet, etc. The network interface 1018 may interface with remote sites or networks via wired or wireless connections.

Control logic 1028C may be transmitted to and from the computer 1002 via the communication medium 1024B. More particularly, the computer 1002 may receive and transmit carrier waves (electromagnetic signals) modulated with control logic 1030 via the communication medium 1024B.

Any tangible apparatus or article of manufacture comprising a computer useable or readable medium having control logic (software) stored therein is referred to herein as a computer program product or program storage device. This includes, but is not limited to, the computer 1002, the main memory 1008, secondary storage devices 1010, the removable storage unit 1016 but not the carrier waves modulated with control logic 1030. Such computer program products, having control logic stored therein that, when executed by one or more data processing devices, cause such data processing devices to operate as described herein, represent embodiments of the invention.

Embodiments of the invention can work with software, hardware, and/or operating system implementations other than those described herein. Any software, hardware, and operating system implementations suitable for performing the functions described herein can be used. Embodiments of the invention are applicable to both a client and to a server or a combination of both.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A computer-implemented method for roof generation of three dimensional (3D) models, comprising:
receiving aerial imagery and a plurality of 3D model facades, wherein the plurality of 3D model facades are generated based on ground acquired facade data; and
generating a roof connecting the plurality of 3D model facades,
wherein the receiving and generating steps are performed using one or more processors.

2. The method of claim 1, further comprising:
generating a triangulated mesh representing received 3D model facade edges;
aligning the aerial imagery with the plurality of 3D model facades to generate aligned aerial imagery; and
texturing the generated roof with the aligned aerial imagery.

3. The method of claim 1, wherein the generating step comprises a Delaunay triangulation of a top-down view of the facade edges.

4. The method of claim 1, further comprising:
labeling the facade edges in the triangulated mesh as being inside or outside a 3D model.

5. The method of claim 4, wherein the labeling step comprises determining an interiorness factor associated with the facade edges.

6. The method of claim 1, wherein the aligning step further comprises:
aligning the aerial imagery with the 3D model facades using edge detection of the aerial imagery.

7. The method of claim 6, further comprising:
extracting a portion of the aerial imagery.

8. The method of claim 7, further comprising:
producing an edge using the extracted portion of the aerial imagery;
linking edge pixels in the edge image; and
constructing a plurality of line segments using the linked edge pixels.

9. The method of claim 8, further comprising:
computing a luminance difference based on luminance values on each side of a constructed line segment; and
selecting a location in the aerial imagery with a highest value of luminance difference.

10. The method of claim 1, wherein the aligning step further comprises:
aligning the aerial imagery with the facades using an entropy value of the aerial imagery.

11. The method of claim 10, further comprising:
extracting a portion of the aerial imagery.

12. The method of claim 11, further comprising:
constructing a template image using the extracted portion of the aerial imagery, wherein the template image includes dark and bright regions; and
aligning a transition between the dark and bright regions parallel to each facade edge.

13. The method of claim 12, further comprising:
determining a value of translation that maximizes mutual information between the constructed template image and the aerial imagery.

14. A computer-based system for roof generation of three dimensional (3D) models, comprising:
a grouping module, implemented using one or more processors, configured to receive aerial imagery and a plurality of 3D model facades, wherein the plurality of 3D model facades are generated based on ground acquired facade data;
an alignment module configured to align the aerial imagery with the plurality of 3D model facades to generate aligned aerial imagery; and
a roof generation module configured to generate a roof connecting the plurality of 3D model facades and to texture the roof with the aligned aerial imagery,
wherein the alignment module and the roof generation module are implemented using the one or more processors.

15. A computer program product including a non-transitory computer readable medium having control logic stored therein for execution on one or more computer processors, said control logic enabling the one or more processors to perform roof generation of three dimensional (3D) models according to a method, the method comprising:
receiving aerial imagery and a plurality of 3D model facades; and
generating a roof connecting the plurality of 3D model facades.

16. The computer program product of claim 15, the method further comprising:
generating a triangulated mesh representing received 3D model facade edges;
aligning the aerial imagery with the plurality of 3D model facades to generate aligned aerial imagery; and
texturing the generated roof with the aligned aerial imagery.

17. The computer program product of claim 16, wherein the generating step comprises a Delaunay triangulation of a top-down view of the facade edges.

18. The computer program product of claim 16, the method further comprising:
labeling the facade edges in the triangulated mesh as being inside or outside a 3D model.

19. The computer program product of claim 16, wherein the aligning step further comprises:
aligning the aerial imagery with the 3D model facades using edge detection of the aerial imagery.

20. The computer program product of claim 19, the method further comprising: extracting a portion of the aerial imagery.

21. The computer program product of claim 20, the method further comprising:
producing an edge image using the extracted portion of the aerial imagery;
linking edge pixels in the edge image; and
constructing a plurality of line segments using the linked edge pixels.

22. The computer program product of claim 21, the method further comprising:
computing a luminance difference on both sides of a constructed line segment; and
selecting a location with a highest value of luminance difference.

23. The computer program product of claim 16, wherein the aligning step further comprises:
aligning the aerial imagery with the facades using an entropy value of the aerial imagery.

24. The computer program product of claim 23, the method further comprising: extracting a portion of the aerial imagery.

25. The computer program product of claim 24, the method further comprising:
constructing a template image using the extracted portion of the aerial imagery, wherein the template image includes dark and bright regions; and
aligning a transition between the dark and bright regions parallel to each facade edge.

26. The computer program product of claim 25, the method further comprising:
determining a value of translation that maximizes mutual information between the constructed template images and the aerial imagery.
